(19) United States
(12) Patent Application Publication
(10) Pub. No.: US 2024/0243599 A1
(43) Pub. Date: Jul. 18, 2024

(54) ELECTRONIC DEVICE AND CHARGING METHOD THEREOF

(71) Applicant: ASUSTeK COMPUTER INC., Taipei City (TW)

(72) Inventors: Ci-An Chen, Taipei City (TW); Yu-Yang Tai, Taipei City (TW)

(73) Assignee: ASUSTeK COMPUTER INC., Taipei City (TW)

(21) Appl. No.: 18/502,090

(22) Filed: Nov. 6, 2023

(30) Foreign Application Priority Data
Jan. 13, 2023 (TW) 112101529

(51) Int. Cl. H02J 7/00; H02M 3/158

(52) U.S. Cl. CPC H02J 7/00712; H02J 7/00032; H02J 7/0042; H02J 7/0047; H02M 3/1582; H02J 2207/20

(57) ABSTRACT

An electronic device is provided. The electronic device includes a connection interface, a boost-buck charger, a voltage converter, a boost-buck circuit, a power control chip and a controller. The boost-buck charger is configured to provide a system voltage. The voltage converter generates a first charging voltage based on the system voltage. The boost-buck circuit includes a boost-buck converter. When the connection interface is coupled with an external device, the power control chip communicates with the external device through a power control protocol and enables the boost-buck converter to generate a second charging voltage, higher than the first charging voltage, based on the system voltage according to a charging requirement of the external device. The controller decides to provide the first charging voltage or the second charging voltage to the external device according to the charging requirement of the external device.

### CROSS-REFERENCE TO RELATED APPLICATION

This application claims the priority benefit of Taiwan application serial no. 112101529, filed on Jan. 13, 2023. The entirety of the above-mentioned patent application is hereby incorporated by reference herein and made a part of this specification.

### BACKGROUND

### Technical Field

The present disclosure relates to an electron device which improves the charging efficiency of an external device and a charging method thereof.

### Description of Related Art

In recent years, manufacturers of portable devices (such as smart phones) have successively launched products with large-capacity batteries, and high battery endurance has become one of the indicators for purchasing portable devices. With the availability of high-endurance and large-capacity batteries, the fast charging technology for portable devices has flourished, and consumers have begun to pay attention to the charging time of portable devices. In response to this, today's electronic devices are usually equipped with a hardware connection interface of the Universal Serial Bus (USB) Type-C communication standard. This USB Type-C interface provides ultra-high-speed charging mode and has a transfer rate of up to 10 Gbps.

However, in the traditional architecture, the charging voltage provided by the USB is limited to 5 volts, and the maximum current can only be matched with 3 amperes. As a result, the maximum wattage of power supply is only 15 watts, which creates a bottleneck that is difficult to break through in charging capacity.

### SUMMARY

The present disclosure provides an electronic device, which includes a connection interface, a boost-buck charger, a voltage converter, a boost-buck circuit, a power source control chip and a controller. The boost-buck charger is coupled with the connection interface to provide the system voltage. The voltage converter is coupled with the boost-buck charger to generate the first charging voltage based on the system voltage. The boost-buck circuit is coupled with the connection interface and the boost-buck charger, and the boost-buck circuit includes a boost-buck converter. The power source control chip is coupled with the connection interface, the voltage converter and the boost-buck circuit. When the connection interface is coupled with the external device, the power control chip communicates with the external device through the power control protocol, and according to the charging requirement of the external device, enables the boost-buck converter to generate a second charging voltage greater than the first charging voltage based on the system voltage. The controller is coupled with the boost-buck charger, the boost-buck circuit and the power source control chip. The controller decides to provide the first charging voltage or the second charging voltage to the external device according to the charging requirement of the external device.

The present disclosure also provides a charging method suitable for an electron device including connection interface and boost-buck circuit. The boost-buck circuit includes a boost-buck converter. The above method includes the following steps: generating a first charging voltage based on the system voltage; and when the connection interface being coupled with the external device, communicating with the external device through a power control protocol, and according to the charging requirement of the external device, enabling the boost-buck converter to generate a second charging voltage greater than the first charging voltage based on the system voltage, and deciding to provide the first charging voltage or the second charging voltage to the external device.

Based on the above, the electronic device and the charging method thereof of the present disclosure can improve the charging efficiency of the electronic device to the external device, so as to comply with the communication protocol of USB Power Delivery 3.0 (PD 3.0). In this way, the charging time of the external device can be shortened, and the bottleneck of charging capacity can be broken.

In order to make the above-mentioned features and advantages of the present disclosure more comprehensible, the following specific embodiments are described in detail together with the accompanying drawings.

### BRIEF DESCRIPTION OF THE DRAWINGS

FIG. 1 is a schematic block diagram of an electron device according to an embodiment of the present disclosure.

FIG. 2 is a flowchart of a charging method according to an embodiment of the present disclosure.

FIG. 3 is a flowchart of a charging method according to an embodiment of the present disclosure.

FIG. 4 is a schematic block diagram of an electron device according to an embodiment of the present disclosure.

### DESCRIPTION OF THE EMBODIMENTS

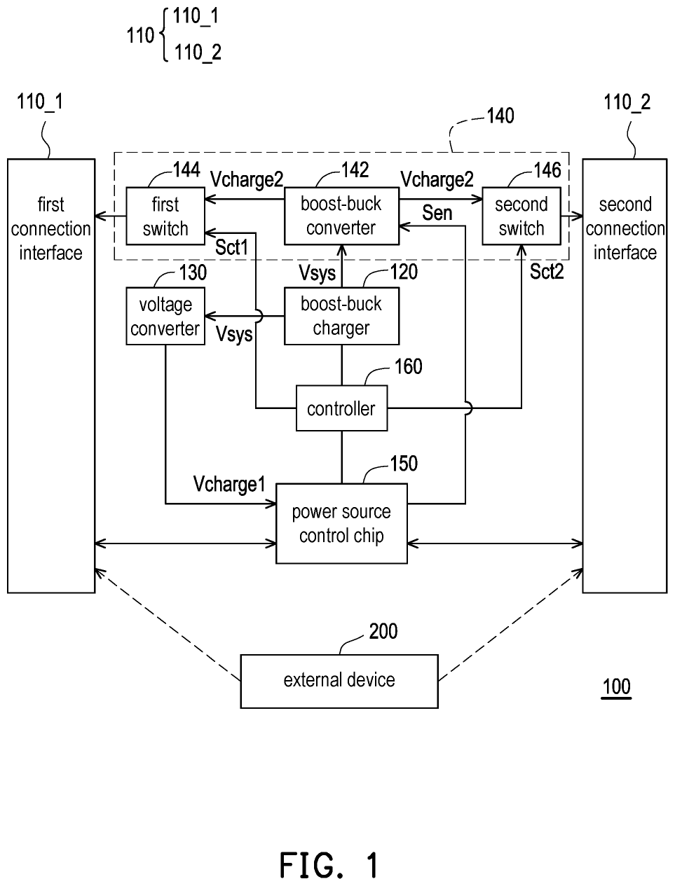

Referring to FIG. 1, the electronic device 100 of this embodiment is, for example, a notebook computer, a tablet computer, and other handheld electronic products that have a charging function for an external device. The electronic device 100 includes a connection interface 110, a boost-buck charger 120, a voltage converter 130, a boost-buck circuit 140, a power source control chip (e.g., Power Delivery IC, PD IC) 150 and a controller 160.

The connection interface 110 may be, for example, a hardware connection interface conforming to the Type-C communication standard of Universal Serial Bus (USB). As shown in FIG. 1, the connection interface 110 includes a first connection interface 110_1 and a second connection interface 110_2. The first connection interface 110_1 and the second connection interface 110_2 may respectively be connection ports including related connection circuits and a plurality of pins, and may at least be used to transmit communication signals, power signals and other related signals through transmission lines.

The boost-buck charger 120 is coupled with the first connection interface 110_1 and the second connection interface 110_2. The boost-buck charger 120 is used to provide the system voltage Vsys to the voltage converter 130 and the boost-buck converter 142. For example, the boost-buck charger 120 may receive the power supply voltage supplied by any one or more of the embedded or external battery module, power adapter and external device, and convert it into a predetermined System voltage Vsys.

The voltage converter 130 is coupled with the boost-buck charger 120. The voltage converter 130 receives the system voltage Vsys, generates a first charging voltage Vcharge1 (for example, 5 volts) based on the system voltage Vsys, and transmits the first charging voltage Vcharge1 to the power source control chip 150.

The boost-buck circuit 140 is coupled with the first connection interface 110_1, the second connection interface 110_2 and the boost-buck charger 120. As shown in FIG. 1, the boost-buck circuit 140 includes a boost-buck converter 142, a first switch 144 and a second switch 146. The first switch 144 and the second switch 146 are, for example, load switch. The first switch 144 is coupled between the first connection interface 110_1 and the boost-buck converter 142, and may be turned on or off under the control of the first control signal Sct1 from the controller 160. The second switch 146 is coupled between the second connection interface 110_2 and the boost-buck converter 142, and may be turned on or off under the control of the second control signal Sct2 from the controller 160. The voltage control and protection settings of the boost-buck converter 142 are set, for example, by the power source control chip 150 at the system initialization of the electron device 100.

The power source control chip 150 is coupled with the first connection interface 110_1, the second connection interface 110_2, the voltage converter 130 and the boost-buck circuit 140. The controller 160 is, for example, a programmable chip such as an embedded controller (EC) or a microcontroller. The controller 160 is coupled with the boost-buck charger 120, the boost-buck circuit 140 and the power source control chip 150. In this embodiment, the boost-buck charger 120, the power source control chip 150, and the controller 160 may be connected with each other through, for example, communication protocols such as System Management Bus (SMBus) or Inter-Integrated Circuit (I²C) for data exchange and communication, but this embodiment is not limited thereto.

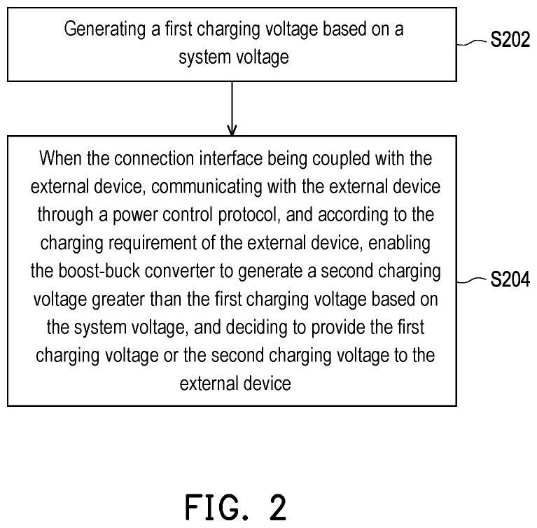

Please refer to FIG. 1 and FIG. 2, the charging method of this embodiment is applicable to the electron device 100 in FIG. 1. The steps of the charging method according to the embodiment of the present disclosure will be described below with various components in the electron device 100.

In step S202, the voltage converter 130 generates a first charging voltage Vcharge1 (for example, 5 volts) based on the system voltage Vsys.

In step S204, when the connection interface 110 is coupled with the external device 200, the power source control chip 150 communicates with the external device 200 through the power control protocol, and according to the charging requirement of the external device 200, enables the boost-buck converter 142 to generate a second charging voltage Vcharge2 (for example, 9 volts) greater than the first charging voltage Vcharge1 based on the system voltage Vsys. Moreover, the controller 160 decides to provide the first charging voltage Vcharge1 or the second charging voltage Vcharge2 to the external device 200 according to the charging requirement of the external device 200.

Specifically, when the external device 200 is coupled with the first connection interface 110_1 or the second connection interface 110_2 (for example, the user inserts the external device 200 from the outside of the electron device 100 into the first connection interface 110_1 or the second connection interface 110_2), the controller 160 can determine whether the charging requirement of the external device 200 meets the second charging voltage Vcharge2. If the charging requirement of the external device 200 meets the second charging voltage Vcharge2 (for example, the charging requirement of the external device 200 is 9 volts/3 amperes), the controller 160 can control the power source control chip 150 to enable the boost-buck converter 142 through the enable signal Sen to generate the second charging voltage Vcharge2 based on the system voltage Vsys. Moreover, the controller 160 can turn on the first switch 144 through the first control signal Sct1 or turn on the second switch 146 through the second control signal Sct2. When the external device 200 is coupled with the first connection interface 110_1, the controller 160 outputs the first control signal Sct1 to the first switch 144 to turn on the first switch 144. When the external device 200 is coupled with the second connection interface 110_2, the controller 160 outputs the second control signal Sct2 to the second switch 146 to turn on the second switch 146. Thereby, the second charging voltage Vcharge2 is transmitted to the external device 200.

If the charging requirement of the external device 200 does not meet the second charging voltage Vcharge2 (for example, the charging requirement of the external device 200 is 5 volts/3 amperes), the controller 160 controls the power source control chip 150 to transmit the first charging voltage Vcharge1 via the first connection interface 110_1 or the second connection interface 110_2 to the external device 200.

In this embodiment, the external device 200 is, for example, an electronic device such as a smart phone, a Personal Digital Assistant (PDA), a notebook computer, and a tablet computer. The power control protocol is, for example, the communication protocol of USB Power Delivery 3.0 (PD 3.0) released by the USB association, but the present disclosure is not limited thereto.

With the above charging method, the charging efficiency of the electronic device 100 to the external device 200 via the connection interface 110 can be improved, so as to comply with the communication protocol of PD 3.0. In this way, the charging time of the external device 200 can be shortened, and the bottleneck of the charging capacity can be broken.

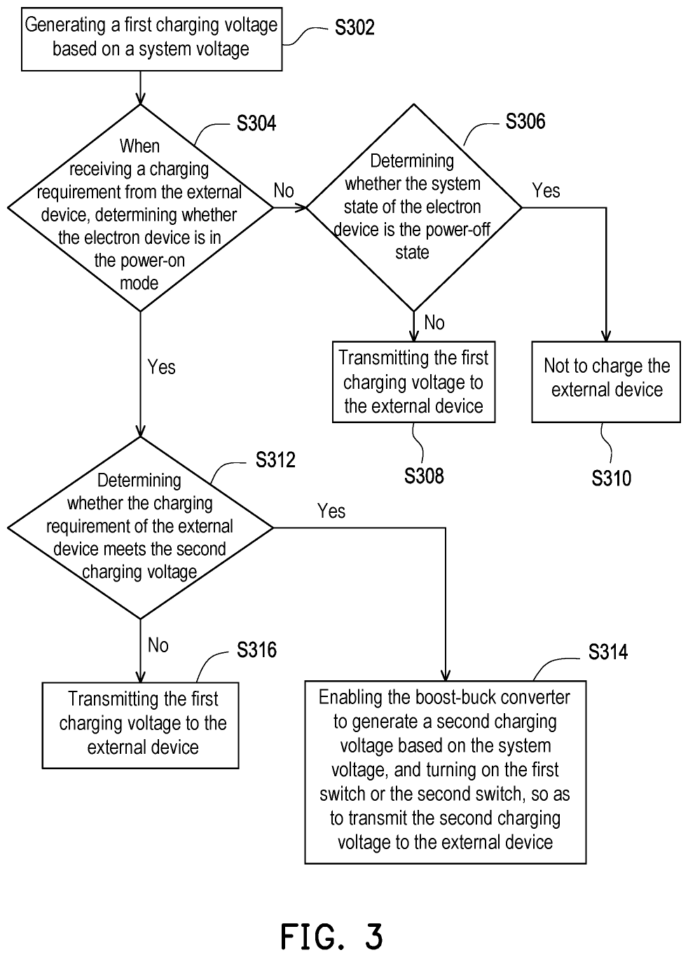

Another embodiment is given below to describe the charging method of the present disclosure in more detail. Please refer to FIG. 1 and FIG. 3, the charging method of this embodiment is applicable to the electron device 100 in FIG. 1. The steps of the charging method according to the embodiment of the present disclosure will be described below with various components in the electron device 100.

In step S302, the voltage converter 130 generates a first charging voltage Vcharge1 based on the system voltage Vsys.

Next, in step S304, when the power source control chip 150 receives a charging requirement from the external device 200, the controller 160 determines whether the electron device 100 is in the power connection mode. Specifically, when the first connection interface 110_1 or the second connection interface 110_2 is coupled with the external device 200, the power source control chip 150 can communicate with the external device 200 through the power control protocol. When the power source control chip 150 receives a charging requirement from the external device 200, the controller 160 determines whether there is a power adapter (such as an AC adapter) inserted into the electron device 100, and then determines whether the electron device 100 is in power connection mode. In this embodiment, when the power adapter is inserted into the electron device 100, the electron device 100 will enter the power connection mode. When the power adapter is pulled out from the electron device 100, the electron device 100 will release the power connection mode.

If the electron device 100 is not in the power connection mode, then in step S306, the controller 160 determines whether the system state of the electron device 100 is the power-off state. In this embodiment, the system state refers to, for example, one of the S0 mode, the S3 mode, the modern standby (MS) mode, and the S5 mode specified by the Advanced Configuration and Power Interface (ACPI), and the power-off state can be regarded as the S5 mode.

When the system state of the electronic device 100 is not the power-off state (such as in the S0 mode, the S3 mode or the MS mode), in step S308, the controller 160 controls the power source control chip 150 to transmit the first charging voltage Vcharge1 via the first connection interface 110_1 or second connection interface 110_2 to the external device 200.

When the system state of the electronic device 100 is the power-off state, in step S310, the controller 160 controls the power source control chip 150 not to charge the external device 200.

If the controller 160 determines in step S304 that the electron device 100 is in the power connection mode, then in step S312, the controller 160 determines whether the charging requirement of the external device 200 meets the second charging voltage Vcharge2.

If the charging requirement of the external device 200 meets the second charging voltage Vcharge2 (for example, the charging requirement of the external device 200 is 9 volts/3 amperes), then in step S314, the controller 160 can control the power source control chip 150 to enable the boost-buck converter 142 through the enable signal Sen to generate a second charging voltage Vcharge2 based on the system voltage Vsys. Moreover, the controller 160 can turn on the first switch 144 through the first control signal Sct1 or turn on the second switch 146 through the second control signal Sct2, so as to transmit the second charging voltage Vcharge2 to the external device 200.

If the charging requirement of the external device 200 does not meet the second charging voltage Vcharge2 (for example, the charging requirement of the external device 200 is 5 volts/3 amperes), then in step S316, the controller 160 controls the power source control chip 150 to transmit the first charging voltage Vcharge1 via the first connection interface 110_1 or the second connection interface 110_2 to the external device 200.

With the above charging method, only when the electron device 100 is in the power connection mode, the high charging voltage (second charging voltage Vcharge2) will be provided to the external device 200, so as to avoid the electron device 100 rapid and largely consuming the battery power and then reducing standby time when the electron device 100 is not in the power connection mode. In one embodiment, even when the electronic device 100 is in the power connection mode, it can be set to stop providing high charging voltage to the external device when the remaining battery power is less than 20%, so as to save battery power consumption.

It should be noted that although the above embodiment is described with the electron device 100 including two connection interfaces, the number of the above connection interfaces is not used to limit the present disclosure. Those skilled in the art can analogize the number of connection interfaces to more according to the actual needs and with reference to the teaching of this embodiment.

In one embodiment, in addition to the second charging voltage Vcharge2, the controller 160 can also control the boost-buck converter 142 through the power source control chip 150 according to the charging requirement of the external device 200 to generate a third charging voltage that meets the charging requirement based on the system voltage Vsys, and transmit the third charging voltage to the external device 200. For example, when the external device 200 has a higher charging voltage requirement, the boost-buck converter 142 can also generate a third charging voltage of 15 volts or 20 volts based on the system voltage Vsys to meet the charging requirement of the external device 200.

In one embodiment, when the second charging voltage Vcharge2 is provided to the external device 200, the controller 160 can continue to control the boost-buck converter 142 via the power source control chip 150 according to the charging requirement of the external device 200 with a predetermined step size (for example, 20 millivolts) within a predetermined range (for example, between 3.3 volts and 20 volts), gradually fine-tune the second charging voltage Vcharge2 to more properly match the current state of the external device 200.

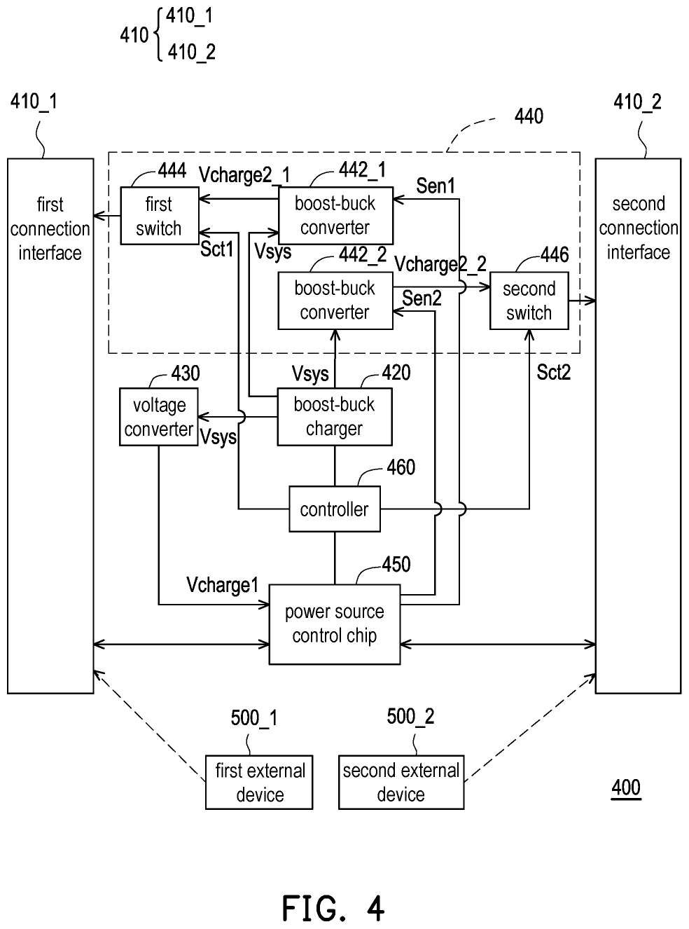

In one embodiment, two boost-buck converters may be configured in the boost-buck circuit to charge two external devices simultaneously. Referring to FIG. 4, the electron device 400 includes a connection interface 410, a boost-buck charger 420, a voltage converter 430, a boost-buck circuit 440, a power source control chip 450 and a controller 460. The connection interface 410 includes a first connection interface 410_1 and a second connection interface 410_2. The action modes of first connection interface 410_1, second connection interface 410_2, boost-buck charger 420 and voltage converter 430 are the same or similar to those of first connection interface 110_1, second connection interface 110_2, boost-buck charger 120 and voltage converter 130 in the foregoing embodiments. Therefore, its details will not be repeated here.

Different from the previous embodiments, in this embodiment, the boost-buck circuit 440 includes two boost-buck converters 442_1 and 442_2, a first switch 444 and a second switch 446. The first switch 444 is coupled between the first connection interface 410_1 and the boost-buck converter 442_1, and can be turned on or off under the control of the first control signal Sct1 from the controller 460. The second switch 446 is coupled between the second connection interface 410_2 and another boost-buck converter 442_2, and can be turned on or off under the control of the second control signal Sct2 from the controller 460.

When the first external device 500_1 is coupled with the first connection interface 410_1, the controller 460 can determine whether the charging requirement of the first external device 500_1 meets the second charging voltage Vcharge2_1 (for example, 9 volts). If the charging requirement of the external device 200 meets the second charging voltage Vcharge2_1 (for example, the charging requirement of the first external device 500_1 is 9 volts/3 amperes), the controller 460 can control the power source control chip 450 to enable the boost-buck converter 442_1 through the first enabling signal Sen1 to generate a second charging voltage Vcharge2_1 based on the system voltage Vsys. Moreover, the controller 460 can turn on the first switch 444 through the first control signal Sct1.

Similarly, when the second external device 500_2 is coupled with the first connection interface 410_2, the controller 460 can determine whether the charging requirement of the second external device 500_2 meets the second charging voltage Vcharge2_2 (for example, 9 volts). If the charging requirement of the second external device 500_2 meets the second charging voltage Vcharge2_2 (for example, the charging requirement of the second external device 500_2 is 9 volts/3 amperes), the controller 460 can control the power source control chip 450 to enable the boost-buck converter 442_2 through the second enabling signal Sen2 to generate a second charging voltage Vcharge2_2 based on the system voltage Vsys. Moreover, the controller 460 can turn on the second switch 446 through the first control signal Sct1.

In this way, even if the first external device 500_1 and the second external device 500_2 are both coupled with the connection interface 410, the boost-buck circuit 440 can simultaneously transmit the high charging voltage (second charging voltage Vcharge2_1 and second charging voltage Vcharge2_2) to the first external device 500_1 and the second external device 500_2, thus improving the convenience of use.

To sum up, the electron device and the charging method thereof of the present disclosure can provide an appropriate charging voltage according to the charging requirement of the external device, and improve the charging efficiency of the electronic device for the external device. In this way, the charging time of the external device can be shortened, the bottleneck of the charging capacity can be broken, and the convenience of use can be improved.

What is claimed is:

1. An electron device, comprising:
a connection interface;
a boost-buck charger, coupled with the connection interface to provide a system voltage;
a voltage converter, coupled with the boost-buck charger to generate a first charging voltage based on the system voltage;
a boost-buck circuit, coupled with the connection interface and the boost-buck charger, wherein the boost-buck circuit includes a boost-buck converter;
a power source control chip, coupled with the connection interface, the voltage converter and the boost-buck circuit, wherein when the connection interface is coupled with an external device, the power source control chip communicates with the external device through a power control protocol, and according to a charging requirement of the external device enables the boost-buck converter to generate a second charging voltage greater than the first charging voltage based on the system voltage; and
a controller, coupled with the boost-buck charger, the boost-buck circuit and the power source control chip, and according to the charging requirement of the external device deciding to provide the first charging voltage or the second charging voltage to the external device.

2. The electronic device according to claim 1, wherein the connection interface includes a first connection interface and a second connection interface, and the boost-buck circuit further includes:
a first switch, coupled between the first connection interface and the boost-buck converter, controlled by a first control signal to be turned on or off; and
a second switch, coupled between the second connection interface and the boost-buck converter, controlled by a second control signal to be turned on or off.

3. The electronic device according to claim 2, wherein when the external device is coupled with the first connection interface or the second connection interface, the controller determines whether the charging requirement of the external device meets the second charging voltage,
if the charging requirement of the external device meets the second charging voltage, the controller controls the power source control chip to enable the boost-buck converter through an enable signal so that the boost-buck converter generates the second charging voltage based on the system voltage, and the controller turns on the first switch through the first control signal or turns on the second switch through the second control signal, thereby transmitting the second charging voltage to the external device,
if the charging requirement of the external device does not meet the second charging voltage, the controller controls the power source control chip to transmit the first charging voltage to the external device.

4. The electronic device according to claim 3, wherein when the controller determines that the charging requirement of the external device meets the second charging voltage, the controller outputs the first control signal to the first switch to turn on the first switch when the external device is coupled with the first connection interface, and the controller outputs the second control signal to the second switch to turn on the second switch when the external device is coupled with the second connection interface.

5. The electronic device according to claim 1, wherein when the power source control chip receives the charging requirement from the external device, the controller determines whether the electron device is in a power connection mode,
if the electron device is in the power connection mode, the controller determines whether the charging requirement of the external device meets the second charging voltage,
if the electron device is not in the power connection mode, the controller determines whether a system state of the electron device is a power-off state, and when the system state of the electron device is not the power-off state, the controller controls the power source control chip to transmit the first charging voltage to the external device, and when the system state of the electronic device is the power-off state, the controller controls the power source control chip not to charge the external device.

6. The electronic device according to claim 5, wherein when a power adapter is inserted into the electron device, the electron device enters the power connection mode, and when the power adapter is pulled out from the electron device, the electron device cancels the power connection mode.

7. The electronic device according to claim 1, wherein the controller controls the boost-buck converter to generate a third charging voltage meeting the charging requirement based on the system voltage according to the charging requirement of the external device, and transmits the third charging voltage to the external device.

8. The electronic device according to claim 1, wherein when the second charging voltage is provided to the external device, the controller continuously controls the boost-buck converter to gradually fine-tune the second charging voltage with a predetermined step size according to the charging requirement of the external device.

9. The electronic device according to claim 1, wherein the boost-buck circuit includes two boost-buck converters, the connection interface includes a first connection interface and a second connection interface, and the boost-buck circuit further includes:
a first switch, coupled between the first connection interface and one of the boost-buck converters, controlled by a first control signal to be turned on or off; and
a second switch, coupled between the second connection interface and another one of the boost-buck converters, controlled by a second control signal to be turned on or off,
the external device includes a first external device and a second external device,
when the first external device is coupled with the first connection interface, the controller determines whether the charging requirement of the first external device meets the second charging voltage,
if the charging requirement of the first external device meets the second charging voltage, the controller controls the power source control chip to enable one of the boost-buck converters through a first enable signal so that the one of the boost-buck converters generates the second charging voltage based on the system voltage, and the controller turns on the first switch through the first control signal, thereby transmitting the second charging voltage to the first external device,
when the second external device is coupled with the second connection interface, the controller determines whether the charging requirement of the second external device meets the second charging voltage,
if the charging requirement of the second external device meets the second charging voltage, the controller controls the power source control chip to enable the other boost-buck converter through a second enabling signal so that the other boost-buck converter generates the second charging voltage based on the system voltage, and the controller turns on the second switch through the second control signal, thereby sending the second charging voltage to the second external device.

10. A charging method suitable for an electronic device including a connection interface and a boost-buck circuit, wherein the boost-buck circuit includes a boost-buck converter, the charging method includes following steps:
generating a first charging voltage based on a system voltage; and
when the connection interface being coupled with an external device, communicating with the external device through a power control protocol, and according to a charging requirement of the external device, enabling the boost-buck converter to generate a second charging voltage greater than the first charging voltage based on the system voltage, and deciding to provide the first charging voltage or the second charging voltage to the external device.

11. The charging method according to claim 10, wherein the connection interface includes a first connection interface and a second connection interface, the boost-buck circuit further includes a first switch and a second switch, the first switch is coupled between the first connection interface and the boost-buck converter, the second switch is coupled between the second connection interface and the boost-buck converter,
the step of enabling the boost-buck converter to generate the second charging voltage greater than the first charging voltage based on the system voltage according to the charging requirement of the external device, and deciding to provide the first charging voltage or the second charging voltage to the external device include:
determining whether the charging requirement of the external device meets the second charging voltage;
if the charging requirement of the external device meeting the second charging voltage, enabling the boost-buck converter to generate the second charging voltage based on the system voltage, and turning on the first switch or the second switch, thereby transmitting the second charging voltage to the external device; and
if the charging requirement of the external device not meeting the second charging voltage, transmitting the first charging voltage to the external device.

12. The charging method according to claim 11, wherein the step of turning on the first switch or turning on the second switch includes:
turning on the first switch when the external device is coupled with the first connection interface; and
turning on the second switch when the external device is coupled with the second connection interface.

13. The charging method according to claim 10, further comprising:
when receiving the charging requirement from the external device, determining whether the electron device is in a power connection mode;
if the electron device being in the power connection mode, determining whether the charging requirement of the external device meets the second charging voltage; and
if the electron device being not in the power connection mode, determining whether a system state of the electron device is a power-off state, and when the system state of the electron device being not the power-off state, transmitting the first charging voltage to the external device, and when the system state of the electron device being the power-off state, the external device not being charged.

14. The charging method according to claim 13, wherein when a power adapter is inserted into the electron device, the electron device enters the power connection mode, and when the power adapter is pulled out from the electron device, the electron device cancels the power connection mode.

15. The charging method according to claim 10, further comprising:
according to the charging requirement of the external device, controlling the buck-boost converter to generate a third charge voltage meeting the charging requirement based on the system voltage, and transmitting the third charge voltage to the external device.

16. The charging method according to claim 10, further comprising:
when providing the second charging voltage to the external device, continuously controlling the boost-buck converter to fine-tune the second charging voltage with a predetermined step according to the charging requirement of the external device.

17. The charging method according to claim 10, wherein the boost-buck circuit includes two boost-buck converters, the connection interface includes a first connection interface and a second connection interface, the boost-buck circuit further includes a first switch and a second switch, and the first switch is coupled between the first connection interface and one of the boost-buck converters, the second switch is coupled between the second connection interface and another one of the boost-buck converters,
the external device includes a first external device and a second external device,
the step of enabling the boost-buck converter to generate the second charging voltage greater than the first charging voltage based on the system voltage according to the charging requirement of the external device, and deciding to provide the first charging voltage or the second charging voltage to the external device include:
when coupling the first external device with the first connection interface, determining whether the charging requirement of the first external device meets the second charging voltage;
if the charging requirement of the first external device meeting the second charging voltage, enabling one of the boost-buck converters to generate the second charging voltage based on the system voltage, and turning on the first switch, thereby transmitting the second charging voltage to the first external device;
when coupling the second external device with the second connection interface, determining whether the charging requirement of the second external device meets the second charging voltage; and
if the charging requirement of the second external device meeting the second charging voltage, enabling the another one of the boost-buck converters to generate the second charging voltage based on the system voltage, and turning on the second switch, thereby transmitting the second charging voltage to the second external device.
